(19) United States
(12) Patent Application Publication
(10) Pub. No.: US 2002/0142273 A1
(43) Pub. Date: Oct. 3, 2002

(54) Interactive process learning aid

(76) Inventors: James T. Dollins, Macomb, MI (US); Paul J. Okoniewski, Romeo, MI (US)

Correspondence Address: JEFFREY A. SEDLAR, General Motors Corporation, Legal Staff Mail Code 482-C23-B21, P. O. Box 300, Detroit, MI, 48265-3000, US

(21) Appl. No.: 09/820,589

(22) Filed: Mar. 30, 2001

(51) Int. Cl. G09B 19/00

(52) U.S. Cl. 434/219

(57) ABSTRACT

A business process learning aid includes functions for assisting a user/learner in carrying out tasks associated with completing the business process wherein the functions include a task resource that assists the user/learner in performing a task within the process. The task resource allows the user/learner to selectively access portions of the learning aid wherein process actions are identified with scenario links. Upon linking to the scenario the user/learner is instructed via a demonstrative operation of the actions that the user/learner must take to complete the associated process task. Optionally, the user/learner can initiate audio instructional accompaniment for assistance in the learning experience.

### TECHNICAL FIELD

The present invention relates to training methodology and more particularly, to a learning aid that integrates a business process and an application system so that training and use become merged together so that the user/learner has ongoing access to system and process familiarity for on-the-job training, refreshers, updates and subject matter expert guidance.

### BACKGROUND OF THE INVENTION

In today's business world, employees are inundated with business processes and application system tools of an ever-increasing complexity. The employees themselves have varying levels of competencies across the range of these processes and tools. In addition, new processes and tools are continually being used while those in existence are often upgraded. Traditional training methods accept the complexity of the business process as a given factor that cannot be altered. The training regime instructs learners on the process with all of its complexity so that regardless of the scenario, the learner will preferably be able to recall the training details and address the situation confronted on-the-job in carrying out the business process. Traditional training also accepts the complexity of system tools (i.e. application tools) that must be used by the learner in carrying out the business process as another given factor that cannot be altered. With the complexities accepted and unchallenged, the training system then addresses the shortfall between that complexity and employee skill level by attempting to raise individual skills through training methods. These training methods are often conducted after the process and application tools have been created and rolled out so that employees are constantly trying to keep pace with the demands placed upon them to gain and maintain familiarity with processes and tools. In essence, training has become an afterthought, necessary so that the investment in creating common process and application tools can be recouped.

Within this stressing environment, formal classroom-type training programs may only account for a relatively minor percentage of the actual learning that occurs in attempting to raise the employee skill set to the desired level of complexity necessary to meet organizational goals. On average, a much larger percentage of the actual learning that occurs is precipitated by informal communications with peers and subject matter experts. Also on average, an even larger percentage of all learning may be attributed to experience while employees carry out challenging work assignments on the job.

Unfortunately, continued reliance on traditional training methods has resulted in a widening gap between the preferred employee knowledge level relating to business processes/application tools and the actual skill levels. Formal training has traditionally been comprised of classroom instruction and textbook supplementation. This has expanded to include computer based training, which for the most part follows the traditional course structure model by being packaged in a start-to-finish process of instruction. In reality, computer based training becomes a classroom in which the learner is instructed by the rigid computer program. Such instruction is also supplemented with documentation for later reference. These instructional methods have the drawback of being a stand alone process separate form the business process and application tool, intent on raising skill levels so that the learner becomes more proficient at carrying out the targeted tasks. As a separate process, the training itself does nothing to address the actual complexity of either the business process or the application tool used to carry out the process on a day-to-day basis.

Shortfalls of these conventional training methods are numerous. Classroom training has the inevitable effect of being variable. No two classes are instructed in the identical fashion and the variability can be significant when multiple instructors are involved. In other words, commonality is lacking. Computer based training also suffers from a lack of commonality for those business processes that are long lived. System updates are routine and the reference documentation that accompanies the various versions will inevitably vary. Classroom instruction also carries the additional burden of the need to train the trainers, who themselves are generally intermediaries between the subject matter experts and the learners. Efforts to address these deficiencies have often been made, but such efforts are somewhat misplaced since in the workplace, formal training accounts for such a small percentage of the actual learning that occurs. These efforts also do nothing to address the underlying problem of increasing complexity directly, but rather tend to merely respond to the problem. This leaves the user in an often frustrating position of trying to find answers to how-to questions.

Accordingly, the lack of coordination between training and process/system development has led to a pressing need for efficient value-added training methods that match learning to work assignments, on the job.

### SUMMARY OF THE INVENTION

On a high level, the invention is a tool that allows user/learners to fully envision the actions required to accomplish their assignment. Aspects of the present invention reside in an interactive process learning aid that targets driving down the complexity of business processes by providing business process expertise at employee workstations on the job, and targets driving down application system complexity by building knowledge management into the system tool and making it available at employee workstations. This occurs within the context of the present invention by giving both new and experienced user/learners direct access to the interactive process learning aid with the application tool and the business process supported by that tool at their workstation. The interactive process learning aid includes process work-flow definition along with other business process related categories of assistance. The relation between the business process and the application tool is fleshed-out through process-application scripts that preferably include interactive activities, process steps, logic, cadence and priorities. These components are integrated together electronically and available at employee workstations to provide interactive electronic performance support within the context of a precise model of the business process. Preferably this is achieved on line through a web based learning resource that is constantly in step with process and system upgrades as they occur.

Accordingly, the present invention is embodied in a business process learning aid that includes functions for assisting a user/learner in carrying out tasks associated with completing the business process wherein the functions include a task resource that assists the user/learner in performing a task within the process. The task resource allows the user/learner to selectively access portions of the learning aid wherein process actions are identified with scenario links. Upon linking to the scenario the user/learner is instructed via a demonstrative operation of the actions that the user/learner must take to complete the associated process task. Optionally, the user/learner can initiate audio instructional accompaniment for assistance in the learning experience.

The interactive process learning aid is aimed at matching training with: challenging work assignments; subject matter experts; and peer communications, on the job. This is achieved by building knowledge management into the system tool and making it available to employees at their workstation so that when an application tool is created to carry out a business process the training is integrated into the system.

### BRIEF DESCRIPTION OF THE DRAWINGS

FIG. 1 is a diagrammatic representation of the training architecture model of the present invention.

FIG. 2 is a diagrammatic representation of an embodiment of a system for carrying out the present invention.

FIG. 3 is a diagrammatic representation of an embodiment of the training architecture model of FIG. 1 as carried out in the system of FIG. 2.

FIG. 4 is a representation of the index shown in FIG. 3.

FIG. 5 is a representation of a screen accessed via the distribution list line in the index of FIG. 4.

FIG. 6 is a diagrammatic representation of the screen accessed via the personal distribution list line of FIG. 5.

FIG. 7 is a diagrammatic representation of the screen accessed via the production work orders line of FIG. 4.

FIG. 8 is a diagrammatic representation of the screen accessed via the number 1 of FIG. 7.

FIG. 9 is a diagrammatic representation of the screen accessed via the 1 of FIG. 8.

### DESCRIPTION OF THE PREFERRED EMBODIMENT

### Overview

The Integrated Process Learning Aid is a tool that allows the user/learner to access a model of the integration between a particular business process and the application tool that supports that process. For purposes of the present description, the exemplary business process referenced is a “work order” process used primarily by engineers to initiate and coordinate the design and release of product content. The work order process is used to change, cancel or supersede that product content, as well as to initiate a stop order.

In the exemplary embodiment the invention resides in essence, as an integral part of the work order process and software system so that when rolled out to users, the process and application tool are accessible and support the user in learning the system. The user/learner is taught the relationship between the business process and application tool through a series of process-application scripts. The scripts consist of text and diagram based material supported by voice-over guidance. Within the process-application scripts, the user/learner is guided through activities, steps, logic, cadence and priorities. Features of the application tool that assist the interactive learning process include web screens, user controls, point-and click functionality, and help information. A model of the business process is provided in an interactive form including work process flow, roles and responsibilities, term meaning, lessons learned information, and links to outside resources. These constituents are tied together electronically at the user/learner's workstation to provide interactive online electronic performance support. The intent is to make business process/application tool systems self teaching and to provide learning resources before, during and after the actual hands-on training.

The exemplary application tool referenced is a computer based system with software consisting of eight subsystems: graphical user interface (GUI), documents, distribution, administrative, interrelated system interface, security/profile, data access and database. The subsystems may also rely on ancillary systems to provide additional capabilities such as sign-on and security.

### Training Architecture Model

To begin a more detailed description of the present invention, it is necessary to understand the paradigm of traditional training approaches. With traditional training, business process are created within an organization to achieve desired results. The business process is often supported by an application tool that is made available to employees for support in carrying out the business process. Usually, the levels of complexity of the individual components comprising the business process and the application tool are compounded as a result. The organization then responds to close the gap between process/application complexity and employee skill level by providing training. The training results in a spike in skill level that is often temporary because of upgrades, employee turnover and skill atrophy. This is the situation that the present invention intends to correct.

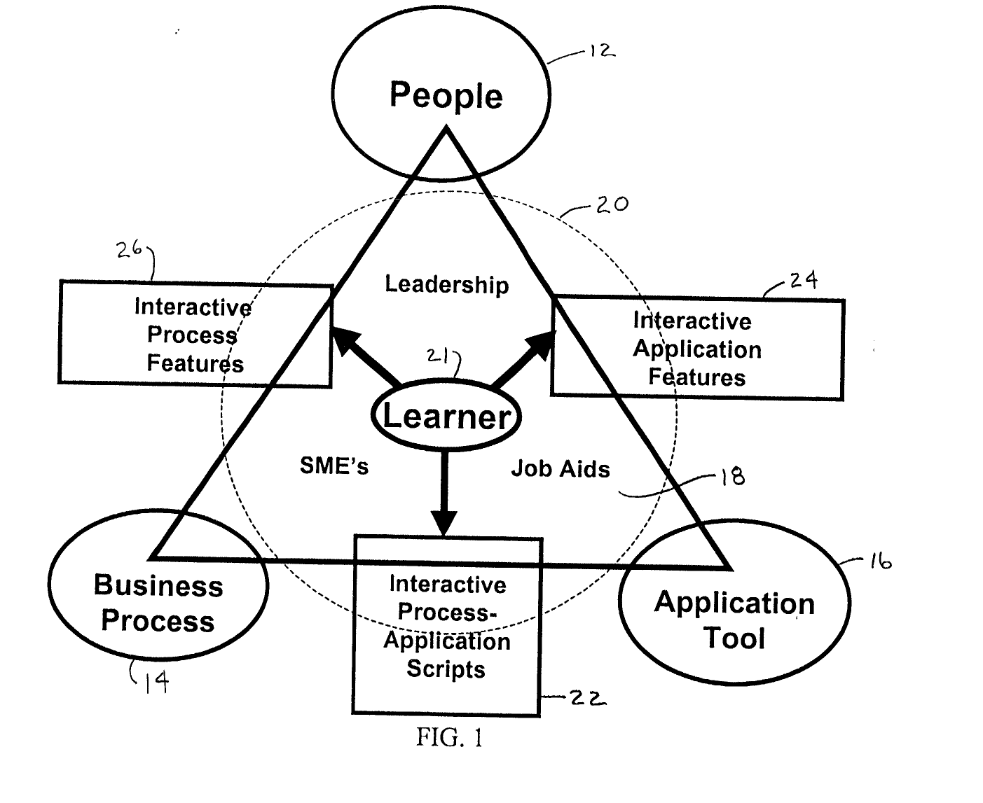

Referencing FIG. 1, the training architecture model underlying the present invention is depicted. The non-intersecting sets of people 12, business process 14 and electronic application tools 16 lie in distinct positions. These sets are bonded together in a conventional manner by the support structure 18 represented as a triangle, which consists of leadership, subject matter experts and job aids including traditional training. The present invention adds considerable new depth to the support structure 18 by overlaying an interactive process learning aid 20 onto the traditional resources. The interactive process learning aid leverages the existing support structure to provide a deeper and much more readily available layer of support.

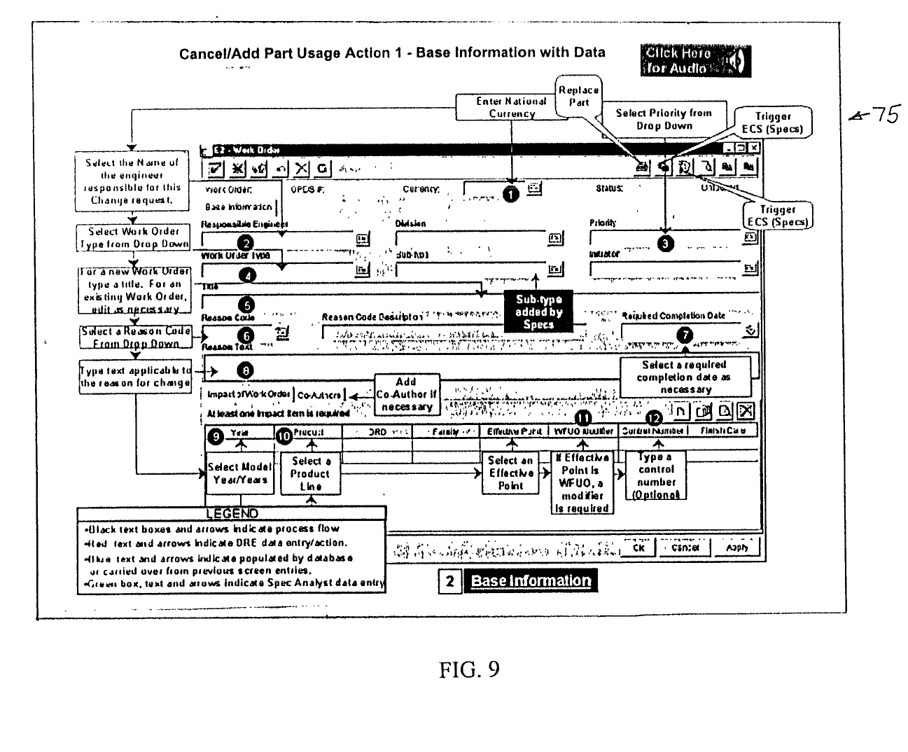

The interactive process learning aid 20 includes interactive process-application scripts 22 that primarily address the relationship between the business process 14 and the application tools. The process application scripts 22 reside in text, diagrams and voice-over material. These materials principally address the activities, steps, logic, cadence and priorities associated with using the application tool to carry out the business process. For example, in the exemplary work order process there are seven types of work orders. each particular type is created using a base screen (FIG. 9), in the application tool. The interactive process-application scripts direct the user/learner through the associates series of steps and actions that are necessary to complete the activity. The learning process includes such things as how to function through the GUI of the application tool 16, and how to complete the actions required of a specific step in the business process before moving on to the next step.

The interactive process learning aid 20 also includes interactive application features 24 that primarily assist the people 12 in interacting with the application tool 16. Included are attributes of the application tool 16 such as web screens, user controls, point and click functionality, single entry, help screens and web speed. The intent is to provide a clear easy to use interface between the user/learner and the application tool.

The interactive process learning aid 20 also includes interactive process features 26 that primarily address the relationship between the business process 14 and the people 12. Included within this category is process flow, roles & responsibilities, workflow, glossary, lessons learned and links. The business process 14 is directly accessible at the employees workstation in an up to date form.

The interactive process learning aid 20, consisting of interactive process-application scripts 22, interactive application features 24 and interactive process features 26 comprises a tool that allows the user/learner 21 as a subset of people 12, to fully envision what must be done to accomplish a job assignment utilizing the application tool 16 to carry out the business process 14, before, during, after or in the absence of, any formal traditional training that is provided. This is achieved with the inclusion of the interactive process learning aid support structure detailed in FIG. 1. The user/learner 21 has access to detailed information and scenarios through the interactive process learning aid site, along with local subject matter experts

### Specific Example

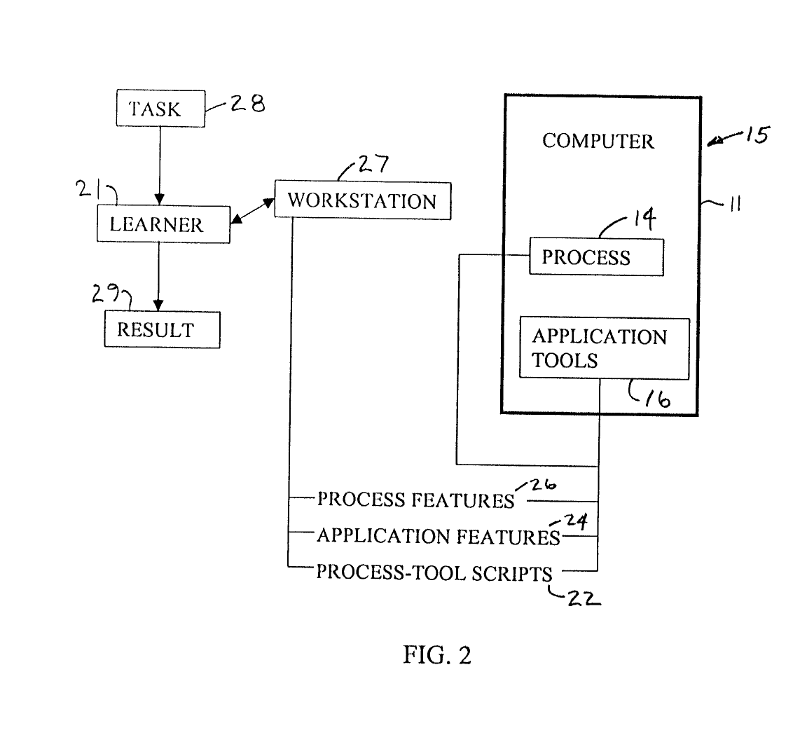

FIG. 2 illustrates an embodiment of the training architecture model is shown in block diagram form. The learner user 21 accesses the process 14 and application 16 administered by one or more computers 11 in a network 15 through a workstation 27. The process features 26, application features 24 and process-tool scripts 22 of the integrated process learning aid also reside within the network and assist the user/learner 21 in completing a task 28 within the process 14 to achieve a desired result 29.

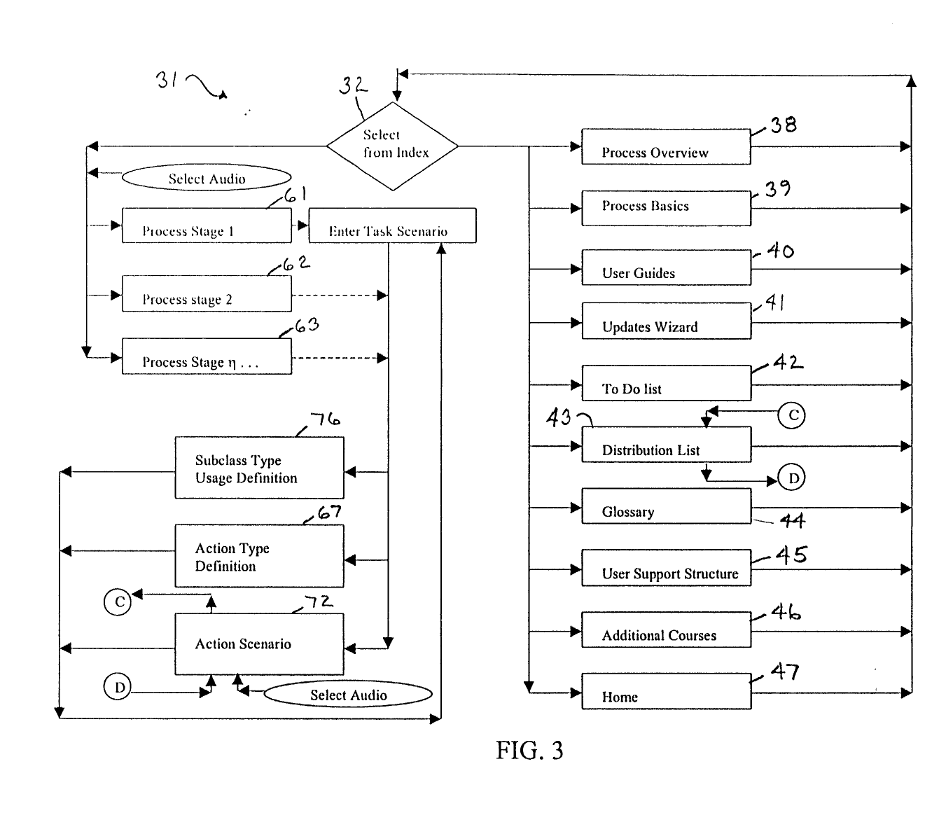

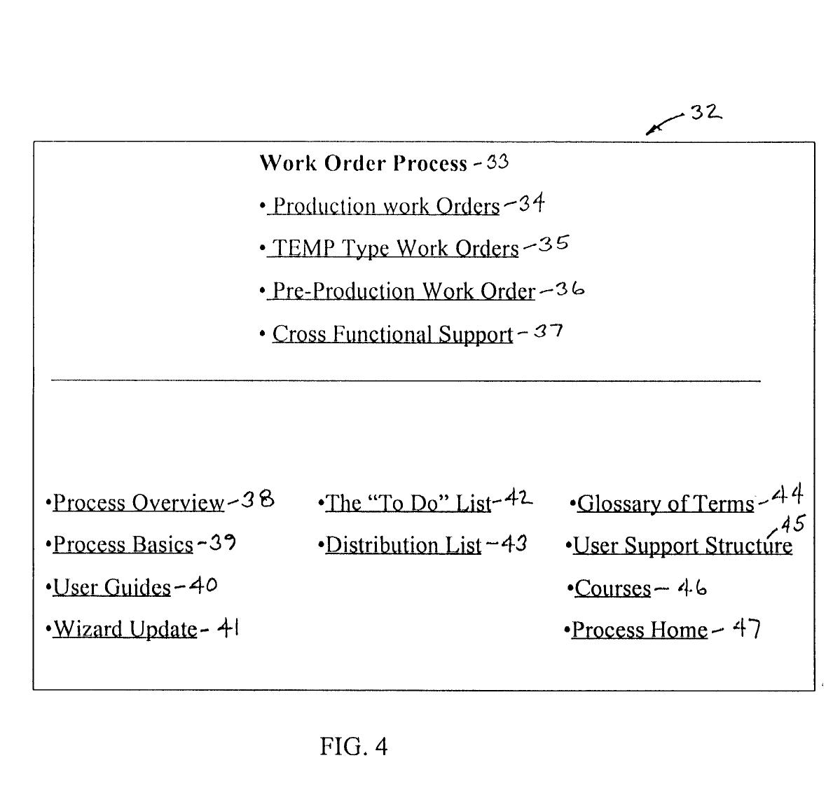

Referring to FIG. 3, a schematic representation of the combined business process and application tool according to the present invention is illustrated. The reference numerals of FIG. 3 are the same as the corresponding reference numerals for the same item in FIGS. 4-9. The user/learner begins by entering learning resource site 31 from within the work order process and application. This permits a user/learner to reference the site 31 while conducting activities with an actual work order for guidance and to switch between learning and using at any time. Upon entry the user/learner is presented with an index shown at step 32, from which a selection may be made of the specific process or sub-process that is the subject matter of the learning exercise. An index example is shown in FIG. 4. Work order process 33 function options include production work orders 34, TEMP type work orders 35, pre-production work orders 36, and cross functional support 37. In addition to work order process function options the index includes supplementary function options including a process overview 38, process basics 39, user guide 40, wizard update 41, the to do list 42, distribution list 43, glossary of terms 44, user support structure 45, conventional courses 46, and a return to the process application home 47 where the work order process is conducted. In addition, an index for training aids of a related process may also be included.

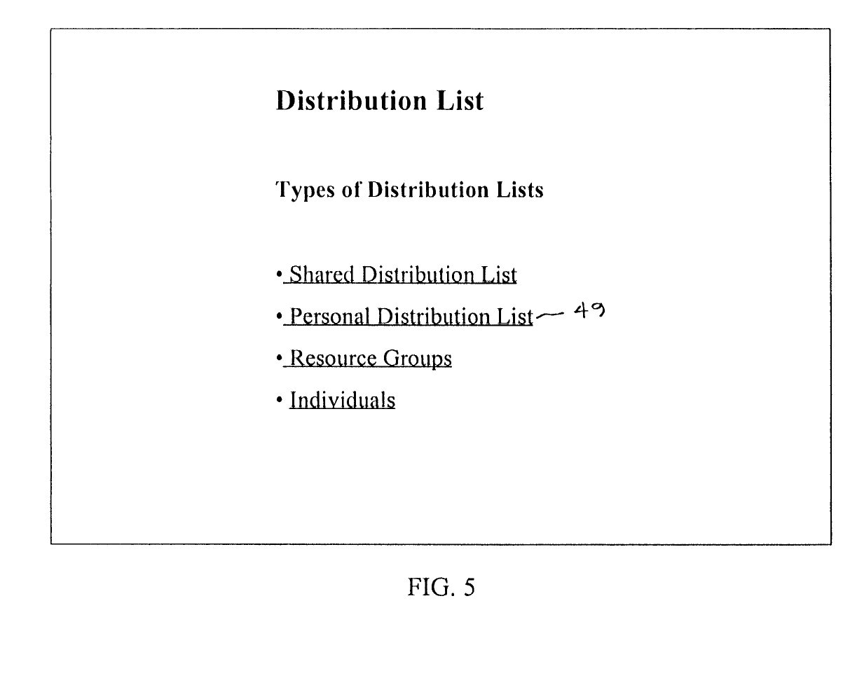

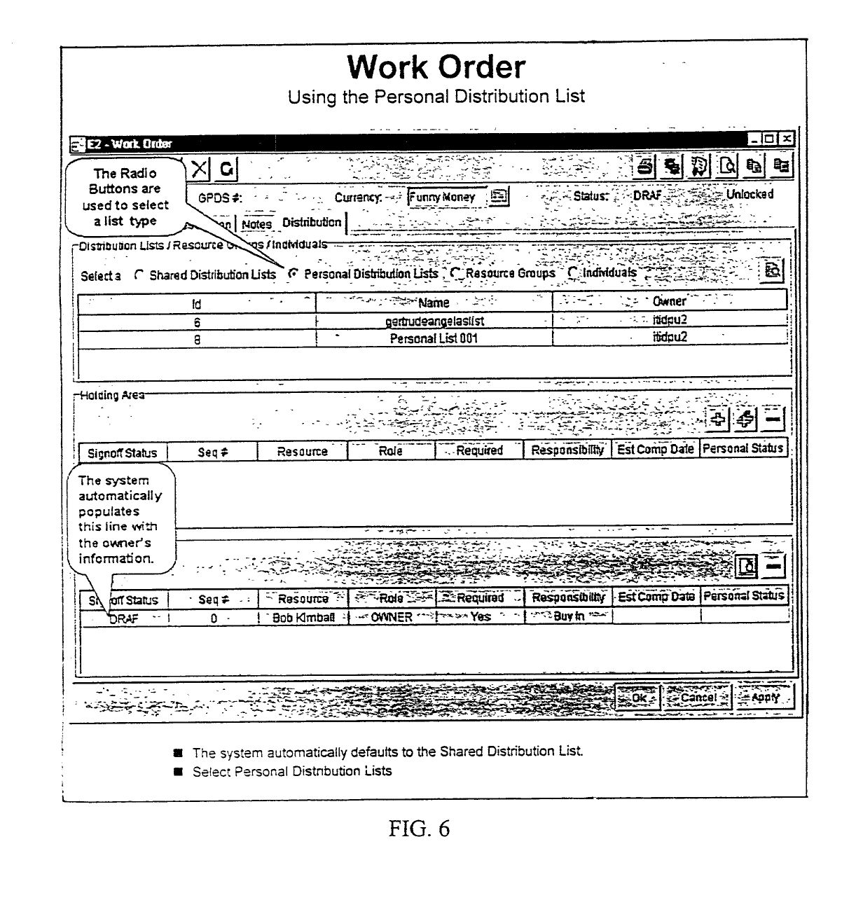

As an example of a supplementary function learning aid, the creation of a distribution list is detailed in block 43 of FIG. 3. This learning aid is entered by selecting distribution lists 43 from the index 32. Since the work order process supports multiple types of distribution lists, a selection is made from a list as represented in FIG. 5. The selection of personal distribution list 49 directs the user/learner to a screen as represented in FIG. 6 and the steps necessary to create a distribution list are described. The screen is an exact model of that used for the task in the business process/application tool. The description takes place through the interactive process-application scripts 22, the interactive application features 24 and the interactive process features 26. At the end of the tutorial the user/learner returns to the index 32 or may return to the process application home at any time when the information sought has been obtained.

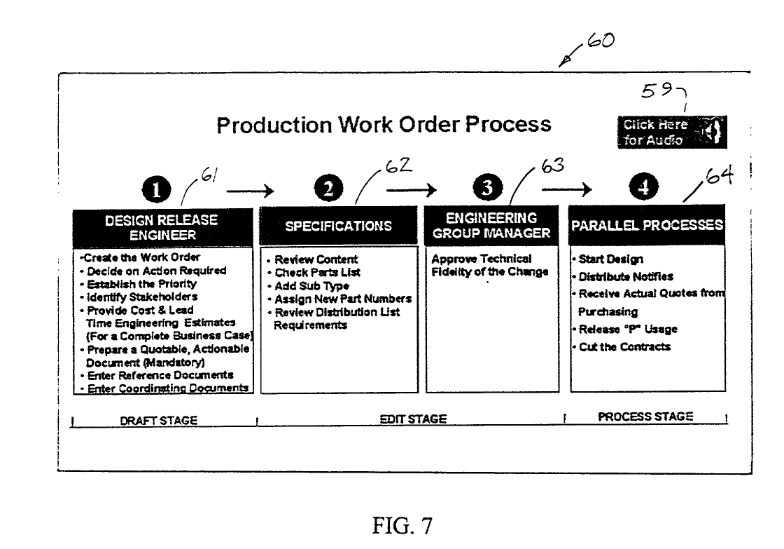

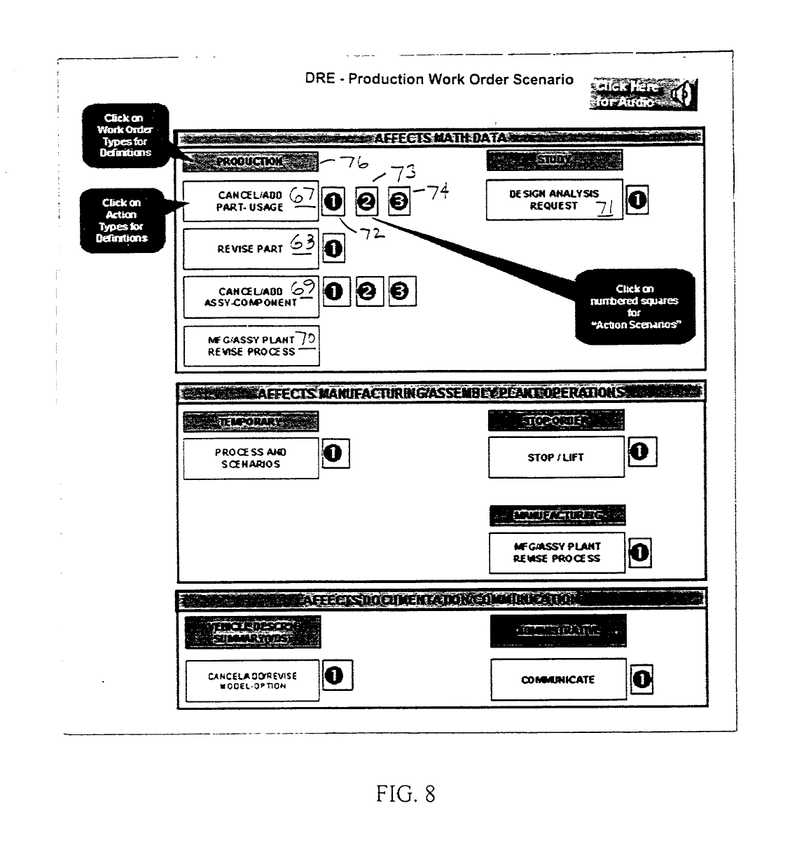

As an example of a process function learning aid, the creation of a work order is detailed by selecting for example, the process subclass for production work orders 34 from the index 32. The user/learner is directed to a screen outlining the production work order process 60 as represented in FIG. 7. The particular process includes draft, edit and process stages. Above each key area, numbered from 1 to 4 are the key functions. To initiate audio instructional support, the user/learner simply clicks on the audio button 59. To obtain further information of the draft stage 61 of the process, the user/learner clicks on number 1. Next the user/learner enters the work order task scenario as shown in FIG. 8. The user/learner is given the option of selecting a task subclass type usage definition by clicking on box 76, an action type definition by clicking on one of the boxes 67-71, or an action scenario related to one of the action types. Of the action types 67-71 involved, as an example the cancel/add part usage action type 67 has three numbered boxes related to three different action scenarios 72-74 for the action. A walk-through of the process steps involved in the actions identified on the scenario buttons is provided. Selecting action scenario 72 directs the user/learner to a base information screen 75 as represented in FIG. 9. This screen is a precise model of the one used in the actual business process. The actions required of the user/learner to cancel or add part usage at the base information screen are detailed. The actions are detailed through textual material and audio content along with clicking and entry. The process of filling in the required fields is defined in a step-by-step approach. If the action of canceling or adding part usage involves actions in other screens, those activities are detailed on succeeding pages. The action scenarios 73 and 74 of FIG. 8 relate to other instances where the canceling or adding of part usage is involved. Since a work order involves a distribution list, the user/learner is given the option of a cross-functional scenario as shown in FIG. 3 wherein direction is provided from the work order action scenario at “C” to the distribution list scenario 43 and when complete, back at “D.” When complete, the user/learner is returned to the screen outlining the production work order process 60 as shown in FIG. 7. Optionally, at any time the user/learner may return to the process application home when the information sought has been obtained to actually carry out the process.

The interactive process learning aid captures process content and system intent in an integrated package. User/learners are able to access the aid before, during and after supplemental training (when provided). The user/learner has ongoing access to process flow, content and system intent for the particular process/ system. The access can be made available on-line, with upgrades globally available to maintain commonality.

1. A process learning aid comprising:
an integrated tool including a model of a business process wherein the business process includes stages defined by a series of roles and tasks linked to an application system defined by an interface, content and scenarios wherein the business process defines the progression of information by the series of roles and tasks; wherein the series of roles and tasks of the business process is supported by guidance from the integrated tool wherein selected portions of the integrated tool are accessed wherein steps of the business process are identified and defined in the model and wherein a scenario provides instruction through the content which defines the roles and demonstrates the actions necessary to complete the tasks through at least one of graphical, audio or textual materials via the interface.

2. A process learning aid comprising:
an integrated tool including a model of a business process wherein the business process includes stages defined by a series of roles and tasks linked to an application system defined by an interface, content and scenarios wherein the business process defines the progression of information by the series of roles and tasks; wherein the series of roles and tasks of the business process is supported by guidance from the integrated tool wherein selected portions of the integrated tool are accessed wherein steps of the business process are identified and defined in the model and wherein a scenario related to a process function provides instruction through the content which defines the roles and demonstrates the actions necessary to complete the process function tasks through at least one of graphical, audio or textual materials via the interface; the scenario including a task stage and an action stage wherein the action stage includes a cross functional link from the process function to a supplementary function, the supplementary function supporting the process function and being outside the process function tasks.

3. A process learning aid comprising:
an integrated tool including a model of a business process wherein the business process includes stages defined by a series of roles and tasks linked to an application system wherein the business process defines the progression of information by the series of roles and tasks; wherein the series of roles and tasks of the business process is supported by guidance from the integrated tool to guide a learner through a task to achieve a result required by the business process; wherein selected portions of the integrated tool are accessed wherein steps of the business process are identified and defined in the model which provides the option of selecting process function categories or related supplementary function categories wherein the process function categories each include a series of stages the stage's roles and tasks defined by the business process and explained by through task scenarios supported by the application system, a task scenario including an action scenario that demonstrates an action type required by the business process the action scenario providing guidance through graphical, audio and textual materials via an interface.
